(19) United States
(12) Patent Application Publication
(10) Pub. No.: US 2016/0191743 A1
(43) Pub. Date: Jun. 30, 2016

(54) METHOD AND SYSTEM FOR LINKING, ATTACHING AND RETRIEVING VIDEO CLIPS ON POSTCARDS

(71) Applicant: Bull HN Information Systems, Inc.

(72) Inventors: SHAHROM KIANI, Onalaska, WI (US); Carlos Macia, La Crescent, MN (US); Russell W. Guenthner, Glendale, AZ (US)

(21) Appl. No.: 14/583,483

(22) Filed: Dec. 26, 2014

(51) Int. Cl. H04N 1/32; G06F 17/30; H04N 1/00; H04W 4/00; G06K 15/02; G06K 1/12

(52) U.S. Cl. CPC H04N 1/32133; G06K 15/021; G06K 1/121; H04N 1/00307; H04N 1/00318; H04W 4/003; G06F 17/30876

(57) ABSTRACT

A process and system for linking, attaching and retrieving video clips on postcards. The process utilizes Quick Response (QR®) codes, computers, smart phones and smart tablets to link, attach and retrieve video clips on a postcard. The system and method will allow senders of a postcard to easily attach a video clip to the postcard. Likewise, the recipients of a postcard will be able to retrieve the attached video clip from the postcard by simply scanning the QR® code on the card.

### CROSS REFERENCE TO RELATED APPLICATIONS

None

### STATEMENT REGARDING FEDERALLY SPONSORED RESEARCH OR DEVELOPMENT

None

### THE NAMES OF PARTIES TO A JOINT RESEARCH AGREEMENT

None

### INCORPORATION BY REFERENCE OF MATERIAL SUBMITTED ON A COMPACT DISC

None

### PROVISIONAL APPLICATION

Attorney/Client Docket Number 60000300P

### BACKGROUND OF THE INVENTION

Postcards are an effective and convenient and typically low cost method for communicating between people. Postcards are typically a lower cost way to send a message than using an envelope. Postcards are also easily viewed and passed from person to person, if a recipient of the postcard wants to share.

Postcards are however limited in space for written communication, and are also typically limited to including only one picture on one side of the postcard.

Quick Response Codes or QR® ® codes are specific matrix barcodes (or two-dimensional codes) that are easily readable by a machine and are especially designed to be read by smart phones and smart tablets. QR® code® is a registered trademark of DENSO WAVE INCORPORATED within the U.S., Japan, Australia and Europe. The code consists of black modules arranged in a square pattern on a white background. The information encoded may be text, a Uniform Resource Locator (URL), or other data. The popularity of QR® codes is increasing each day and they have proven to be an effective way of merging the printed and electronic media.

### BRIEF SUMMARY OF THE INVENTION

The present invention relates generally to mail creation, and more particularly to a method and system for attaching links to video clips on postcards during the postcard creation process as well as for retrieving the video clips after the recipients have received the postcards. There are several Internet-based services that offer websites or smart phone and smart tablet applications that allow users to create and customize their own postcards. Many of these services also offer the option of adding postage for mailing the created postcards directly to the recipients.

It would be very desirable for these services to offer the capability of attaching a video clip to the postcards during the creation process so that when the recipients receive the postcards they can easily access those video clips as well. For example, the invention would allow someone to attach a video clip of a child opening a gift to a Thank You postcard, and after the recipient receives the Thank You postcard the invention would allow them to access the video clip of the child opening the gift. Additional examples could include attaching family video clips for postcards sent to service personnel overseas, for birth announcements, for birthday cards, and for many other greeting or special occasions.

The invention can also be used in commercial applications whereby video clips are attached to advertisement postcards. For example, a video of a home for sale could be attached to the advertisement postcard of a real estate agency.

The invention described herein utilizes Quick Response (QR®®) codes to encode the URL location of a video clip to allow its retrieval from any Internet browser. During a postcard creation process, regardless of whether the process utilizes a personalized Internet-based postcard creation service or a professional commercial mail creation service, a video clip can be selected and uploaded to a computer server that is accessible on the Internet. The URL location of the uploaded video clip is encoded as a QR® ® code and the QR® ® code is printed somewhere on the postcard, preferably in a location that will not interfere with postal processing and will not get damaged during the stamp cancellation step.

After the postcard is received, a recipient can scan the QR® ® code with a QR® ® scanning application typically found on smart phones and smart tablets and the Internet browser in those devices automatically redirects the recipient to the URL location where the video clip can be viewed.

A personalized Internet-based postcard creation service can benefit from the invention irrespective of whether the service is offered from a website or via a smart phone or smart tablet application. When the invention is used from such an Internet-based service, the sender of the postcard is offered the option of attaching a new video clip or selecting a video clip that already exists and is stored in a video album or library on their computer, smart phone or smart tablet. In both cases, the invention uploads the selected video clip to a computer server on the Internet and the URL location of where the video clip is stored on that server is encoded as a QR® code. The invention then adds the QR® code to the postcard so that when the postcard is eventually printed the QR® code is included on it. A commonly recognizable video icon such as a video camera, film strip, TV screen, etc. along with some text such as “video available” or “scan QR® code” may be printed next to the QR® code to indicate that a video clip is available for viewing. This additional aid is intended to create awareness for those that are not very familiar with QR® codes.

A professional commercial mail creation service can also benefit from the invention by encoding QR® codes containing the URL location to video clips owned by their clients. These mail creation services would print the QR® codes during the creation process of any commercial application postcard. For example, a real estate agency could provide the URL location to a video of a home for sale and the mail creator would encode this URL as a QR® code on a real estate advertisement postcard.

Whether the postcard is created by an Internet-based service or by a professional mail creation service, the recipients of the postcards will benefit from the invention in the same manner. Postcard recipients will be able to scan the QR® codes with a smart phone or smart tablet and the QR® scanning application will automatically redirect their Internet browser to the URL location where the video clips can be viewed.

The invention also makes provisions for securing the retrieval of the video clips. In the event that the postcard creator wants to prevent the unauthorized retrieval of video clips, the QR® code can be encoded with a URL location that will redirect the recipients to a website that requires a user name and password to view the video clips.

Part of the process of attaching a QR® code to a postcard may include the creation of a unique serial number that also gets added to the postcard. During the postcard creation this serial number is linked to the sender of the postcard and a list of serial numbers and senders is maintained by the postcard creation service. Such a list can be used by law enforcement agencies to track and investigate certain unlawful activities that may be result from the use of the invention.

Another variation of the invention is intended for recipients that do not have the capability to scan the QR® code. In this variation, the URL location itself may also be placed somewhere on the postcard in a human readable form such as “www.anywebsite.com/videos/video09872282928.htm”. In that case, the recipient would have the option to type in the URL location string directly into an Internet browser in order to access the video clip.

### BRIEF DESCRIPTION OF THE SEVERAL VIEWS OF THE DRAWINGS

The invention is better understood by reading the detailed description of the invention in conjunction with the accompanying figures of the drawing in which:

FIG. 1 illustrates how the invention is used by an Internet-based postcard creation service.;

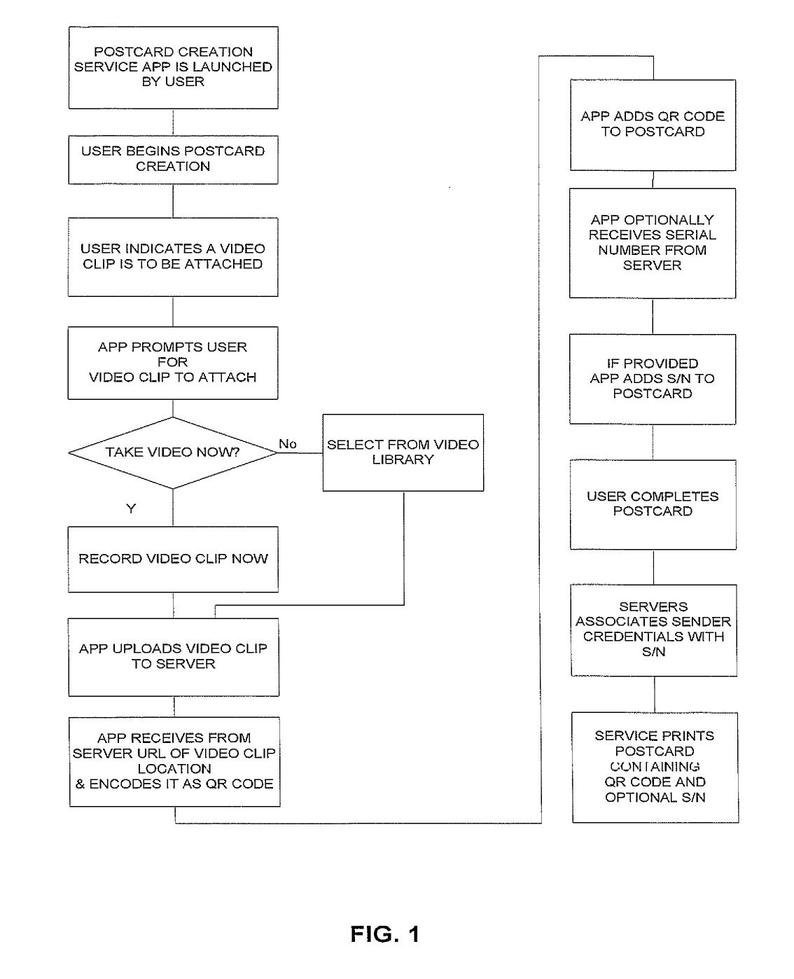

FIG. 2 illustrates how the invention is used by the recipients of postcards; and,

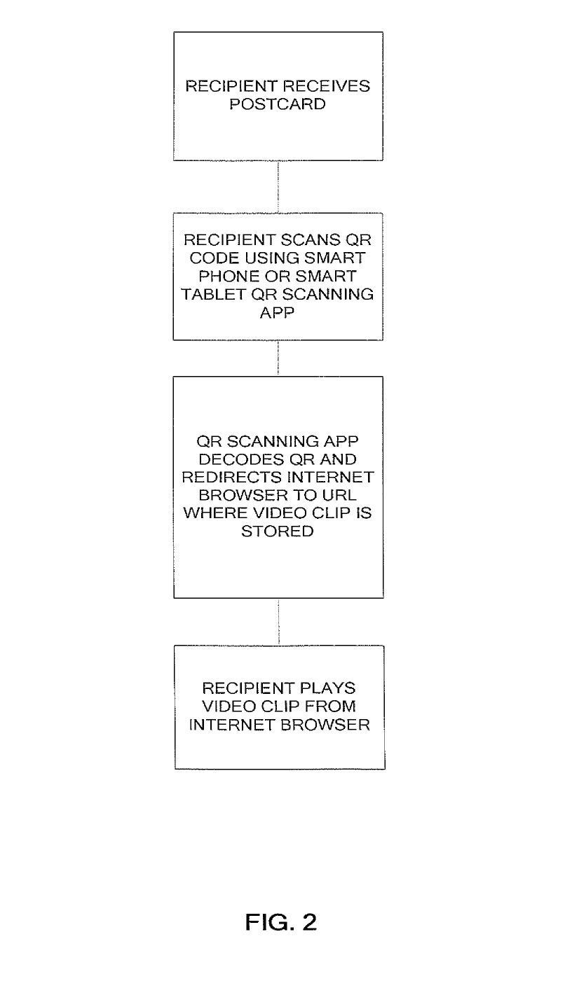

FIG. 3 illustrates how the invention is used by a professional commercial mail creation service.

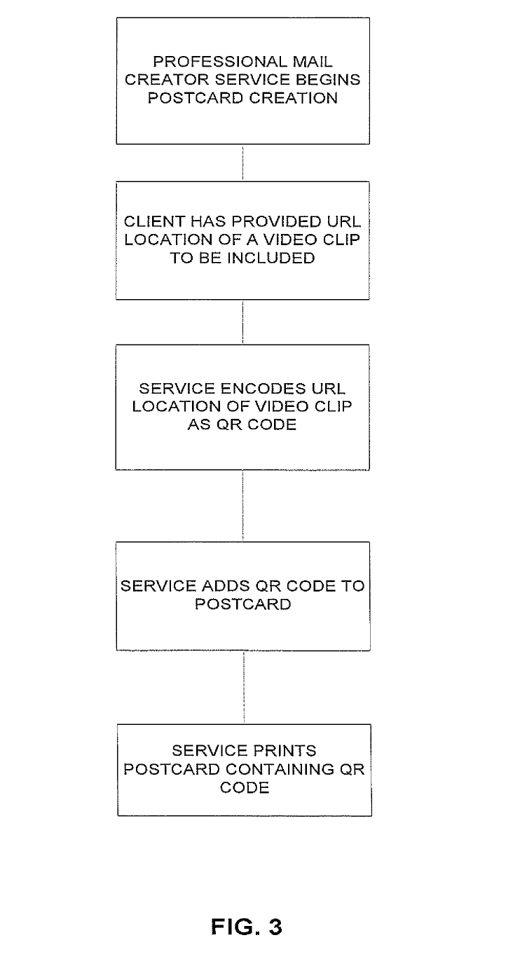

DETAILED DESCRIPTION OF THE INVENTION

What is claimed:

1. A process for printing postcards comprising the steps of:
A. With an Application Program (APP) running on a personal communication device, asking a user of the APP to identify a video clip to be referenced on a postcard;
B. Transfer the identified video clip to a video clip storage location on a web server;
C. Generate a video clip URL (Uniform Resource Locator) that references the identified video clip storage location on the web server;
D. Encode the video clip URL as an associated Quick Response (QR®) code;
E. With the Application Program request user supplied information to be printed on the postcard; and,
F. Print the postcard with the associated QR® code and the user supplied information included on the postcard.

2. The process of claim 1 further comprising a step of the Application Program (APP) asking the user of the APP for a password and if that password is provided, placing the password on the video clip storage location on the web server such that the password must be supplied before the identified video clip is provided to a web browser.

3. The process of claim 1 further comprising a step of mailing the postcard with the associated QR code.

4. A process for printing postcards comprising steps of:
A. Generate a plurality of unique Quick Response Codes (QR® codes), each QR code referencing a unique identified Uniform Resource Locator (URL) location on a web server;
B. Print a plurality of postcards, each postcard including at least one of the unique QR codes generated in Step A;
C. With an Application Program (APP) running on a personal communication device, identify a video clip to be referenced by the unique QR code on one of the plurality of postcards; and,
D. Upload the identified video clip to the web server such that reference by a web browser to the unique identified Uniform Resource Locator (URL) will result in playing of the identified video clip.

5. A process for printing postcards comprising the steps of
A. With an Application Program (APP) running on a personal communication device, identify a video clip to be referenced on a postcard;
B. Transfer the identified video clip to a video clip storage location on a web server, the video storage location on the web server identifiable with a specific URL (Uniform Resource Locator) that references the video clip storage location on the web server;
C. Generate a Quick Response (QR®) code pointing to the specific URL of the identified video clip storage location on the web server;
D. Print the postcard with the associated QR® code;
E. Provide the identified video clip upon request by a web browser that makes reference to the specific URL.

6. The process of claim 5 further comprising a step of placing a password on the video clip storage location on the web server such that the password must be supplied before the identified video clip is provided to the web browser.

7. The process of claim 5 further comprising a step of mailing the postcard with the associated QR code.

8. A process for printing postcards comprising steps of:
A. Generate a plurality of unique Quick Response Codes (QR® codes), each QR code referencing a unique identified Uniform Resource Locator (URL) location on a web server;
B. Print each one of the plurality of unique QR codes generated in Step A on a plurality of postcards;
C. With an Application Program (APP) running on a personal communication device, identify a video clip to be referenced by the unique QR code on one of the plurality of postcards; and,
D. Upload the identified video clip to the web server such that reference by a web browser to the unique identified Uniform Resource Locator (URL) will result in playing of the identified video clip.

9. A process for printing a plurality of mailing items comprising the steps of:
A. With an Application Program (APP) running on a personal communication device and run by an individual user of the APP, asking the individual user of the APP to identify a video clip to be referenced on one of the plurality of mailing items;
B. Transfer the identified video clip to a video clip storage location on a web server;
C. Generate a video clip URL (Uniform Resource Locator) that references the identified video clip storage location on the web server;
D. Encode the video clip URL as an associated Quick Response (QR®) code;
E. With the Application Program request further user supplied information to be printed on the mailing item; and,
F. Print the mailing item with both the associated QR® code and the further user supplied information included on the mailing item.

10. The process of claim 9 further comprising a step of depositing the mailing item with a Postal Service.

11. The process of claim 9 wherein the printing of the mailing item includes printing of an address for delivery of the mail item, the address for delivery of the mail item based upon at least a portion of the further user supplied information.

12. The process of claim 11 further comprising a step of depositing the mailing item with a service for delivery to the address for delivery of the mail item.
